(19) United States
(12) Patent Application Publication
(10) Pub. No.: US 2026/0280427 A1
(43) Pub. Date: Sep. 17, 2026

(54) VOLTAGE CONVERSION SYSTEM AND CONTROL METHOD THEREOF

(71) Applicant: PowerX Semiconductor Corporation, Hsinchu County (TW)

(72) Inventor: Chih-Chieh SU, Hsinchu County (TW)

(21) Appl. No.: 19/273,163

(22) Filed: Jul. 18, 2025

(30) Foreign Application Priority Data
Mar. 14, 2025 (TW) 114109495

(51) Int. Cl. H02M 3/158; H02M 1/00

(52) U.S. Cl. CPC H02M 3/158; H02M 1/0009

(57) ABSTRACT

The present disclosure provides a voltage conversion system and a control method thereof. The voltage conversion system includes a multi-phase voltage converter and a controller. The multi-phase voltage converter is coupled to a load and includes multiple phase circuits. At least one of the phase circuits is in an active state, so that the multi-phase voltage converter provides a load current to the load. The controller is coupled to the multi-phase voltage converter, is used to enable at least one of the phase circuits to be in the active state according to the load current and an activation order of the phase circuits, and is configured to adjust the activation order in response to an activation number of the phase circuits becoming 1, to adjust a first one of the phase circuits from a second priority work item to the highest priority work item.

### RELATED APPLICATIONS

This application claims priority to Taiwan Application Serial Number 114109495, filed Mar. 14, 2025, which is herein incorporated by reference.

### BACKGROUND

### Technical Field

The present disclosure relates to a voltage conversion system and a control method thereof, in particular to a voltage conversion system with an auto phase shedding mechanism and a control method thereof.

### Description of Related Art

With the progress of technologies, various integrated circuits have been developed. For example, a voltage converter can provide a current to power a load. Some related arts use a multi-phase voltage converter. The multi-phase voltage converter includes multiple groups of power switches to power the load adaptively. However, it is one of important issues in this field to improve the efficiency and reliability of the multi-phase voltage converter.

### SUMMARY

An aspect of present disclosure relates to a voltage conversion system. The voltage conversion system includes a multi-phase voltage converter and a controller. The multi-phase voltage converter is coupled to a load and includes a plurality of phase circuits, wherein the plurality of phase circuits are coupled to the load, and at least one of the plurality of phase circuits is in an active state, so that the multi-phase voltage converter provides a load current to the load. The controller is coupled to the multi-phase voltage converter, is configured to enable at least one of the plurality of phase circuits to be in the active state according to the load current and an activation order of the plurality of phase circuits, and is configured to adjust the activation order in response to an activation number of the plurality of phase circuits becoming 1, so as to adjust a first one of the plurality of phase circuits from a second priority work item to a highest priority work item.

Another aspect of present disclosure relates to a control method applicable to a voltage conversion system. The voltage conversion system includes a multi-phase voltage converter, wherein the multi-phase voltage converter includes a plurality of phase circuits, the plurality of phase circuits are configured to couple a load, and at least one of the plurality of phase circuits is in an active state so that the multi-phase voltage converter provides a load current to the load. The control method includes: enabling, by a controller of the voltage conversion system, at least one of the plurality of phase circuits to be in the active state according to the load current and an activation order of the plurality of phase circuits; and adjusting, by the controller, the activation order in response to an activation number of the plurality of phase circuits becoming 1, so as to adjust a first one of the plurality of phase circuits from a second priority work item to a highest priority work item.

### BRIEF DESCRIPTION OF THE DRAWINGS

The disclosure can be more fully understood by reading the following detailed description of the embodiment, with reference made to the accompanying drawings as follows:

FIG. 1 is a circuit block diagram of a voltage conversion system in accordance with some embodiments of the present disclosure;

FIG. 2 is a schematic diagram of multiple voltage levels of a driving signal in accordance with some embodiments of the present disclosure;

FIG. 3 is a circuit block diagram of a controller in accordance with some embodiments of the present disclosure;

FIG. 4 is a flow diagram of a control method in accordance with some embodiments of the present disclosure;

FIG. 5 is a timing diagram of multiple enabling signals under a scenario of load in accordance with some embodiments of the present disclosure;

FIG. 6 is a timing diagram of multiple enabling signals under a scenario of load in accordance with some embodiments of the present disclosure;

FIG. 7 is a timing diagram of multiple enabling signals under a scenario of load in accordance with some embodiments of the present disclosure;

FIG. 8 is a timing diagram of multiple enabling signals under a scenario of load in accordance with some embodiments of the present disclosure;

FIG. 9 is a timing diagram of multiple enabling signals under a scenario of load in accordance with some embodiments of the present disclosure; and

FIG. 10 is a timing diagram of multiple enabling signals under a scenario of load in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

Terms used throughout the specification and the claims of the present disclosure, unless otherwise specified, generally have the ordinary meaning of each term used in the art, in the present disclosure and in special contents.

The term “coupled” or “coupled” used herein may indicate that two or more elements are in direct physical or electrical contact with each other, or that two or more elements are in indirect physical or electrical contact with each other, and also may indicate that two or more elements co-operate or interact with each other.

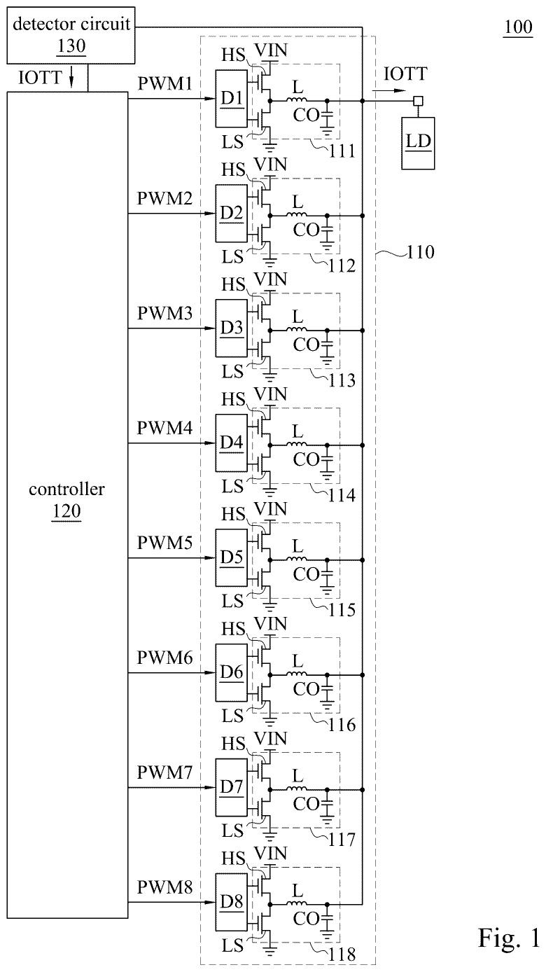

Referring to FIG. 1, FIG. 1 is a circuit block diagram of a voltage conversion system 100 in accordance with some embodiments of the present disclosure. As shown in FIG. 1, the voltage conversion system 100 includes a multi-phase voltage converter 110, a controller 120 and a detector circuit 130. The multi-phase voltage converter 110 is coupled among an input voltage VIN, the controller 120 and a load LD, and the detector circuit 130 is coupled between the multi-phase voltage converter 110 and the controller 120. In particular, the multi-phase voltage converter 110 can be implemented by a voltage converter such as a multi-phase buck converter.

In some embodiments, the multi-phase voltage converter 110 includes multiple driver circuits D1-D8 and multiple phase circuits 111-118. The driver circuits D1-D8 are coupled to the controller 120 and further respectively to the phase circuits 111-118. The phase circuits 111-118 are further coupled to the load LD.

In particular, each of the phase circuits 111-118 includes a high-side switch HS, a low-side switch LS, an inductor L and a capacitor CO. The circuit architecture of each of the phase circuits 111-118 would be described by taking the phase circuit 111 as an example. A first terminal of the high-side switch HS is coupled to the input voltage VIN. A second terminal of the high-side switch HS is coupled to a first terminal of the low-side switch LS and to a first terminal of the inductor L. A second terminal of the low-side switch LS is coupled to a ground terminal. A control terminal of the high-side switch HS and a control terminal of the low-side switch LS are coupled to the driver circuit D1. A second terminal of the inductor L is coupled to a first terminal of the capacitor CO and the load LD. A second terminal of the capacitor CO is coupled to the ground terminal. The other phase circuits 112-118 have circuit structures similar to that of the phase circuit 111, and therefore their circuit structures are omitted herein.

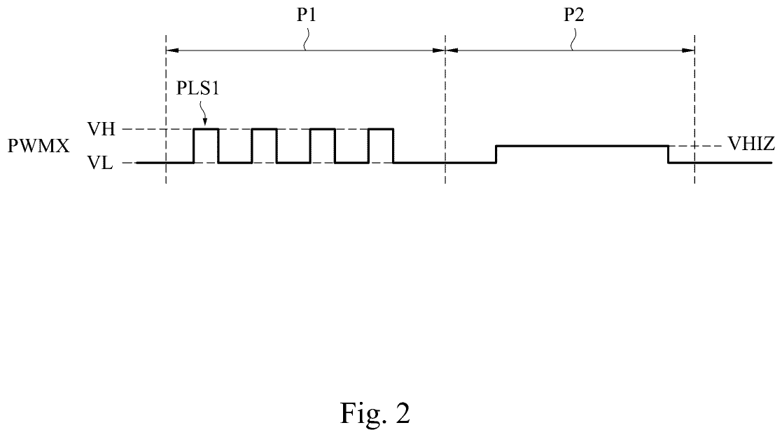

In some embodiments, the driver circuits D1-D8 are configured to drive the phase circuits 111-118 respectively according to a plurality of driving signals PWM1-PWM8 outputted by the controller 120. The circuit operation of each of the driver circuits D1-D8 would be described by taking the driver circuit D1 as an example with reference to FIG. 2. FIG. 2 is a schematic diagram of multiple voltage levels of a driving signal PWMX in accordance with some embodiments of the present disclosure. The voltage levels of the driving signal PWMX in FIG. 2 are applicable to any one of the driving signals PWM1-PWM8 in FIG. 1, that is, X is an integer within a range from 1 to 8.

In accordance with the above descriptions, the driver circuit D1 is configured to control the phase circuit 111 to be in an active state according to the driving signal PWM1, so as to turn on or off the high-side switch HS and the low-side switch LS in the phase circuit 111. For example, when the driving signal PWM1 is at an enable level VH as shown in FIG. 2 (e.g., a voltage level corresponding to logic 1), the driver circuit D1 turns on the high-side switch HS in the phase circuit 111 and turns off the low-side switch LS in the phase circuit 111 to control the phase circuit 111 in the active state to be in a charging state. When the driving signal PWM1 is at a disable level VL as shown in FIG. 2 (e.g., a voltage level corresponding to logic 0), the driver circuit D1 turns off the high-side switch HS in the phase circuit 111 and turns on the low-side switch LS in the phase circuit 111 to control the phase circuit 111 in the active state to be in a discharging state. When the driving signal PWM1 is at a high impedance level VHIZ as shown in FIG. 2 (e.g., a voltage level not corresponding to logic 1 and logic 0), the driver circuit D1 turns off both the high-side switch HS and the low-side switch LS in the phase circuit 111 to control the phase circuit 111 to be in a high impedance state (or a turn-off state). The other driver circuits D2-D8 have circuit operations similar to that of the driver circuit D1, and therefore their circuit operations are omitted herein.

By outputting the driving signal PWM1 that is alternately at the enable level VH and the disable level VL (e.g., the driving signal PWMX during a period P1 in FIG. 2), the driver circuit D1 can drive the phase circuit 111 to output a current (not shown). Also, by outputting the driving signal PWM1 that is maintained at the high impedance level VHIZ (e.g., the driving signal PWMX during another period P2 in FIG. 2), the driver circuit D1 can drive the phase circuit 111 to output no current. In brief, through driving the phase circuits 111-118 to cooperate respectively by the driver circuits D1-D8 (for example, driving at least one of the phase circuits 111-118 to be in the active state), as shown in FIG. 1, the multi-phase voltage converter 110 can provide a load current IOTT to the load LD.

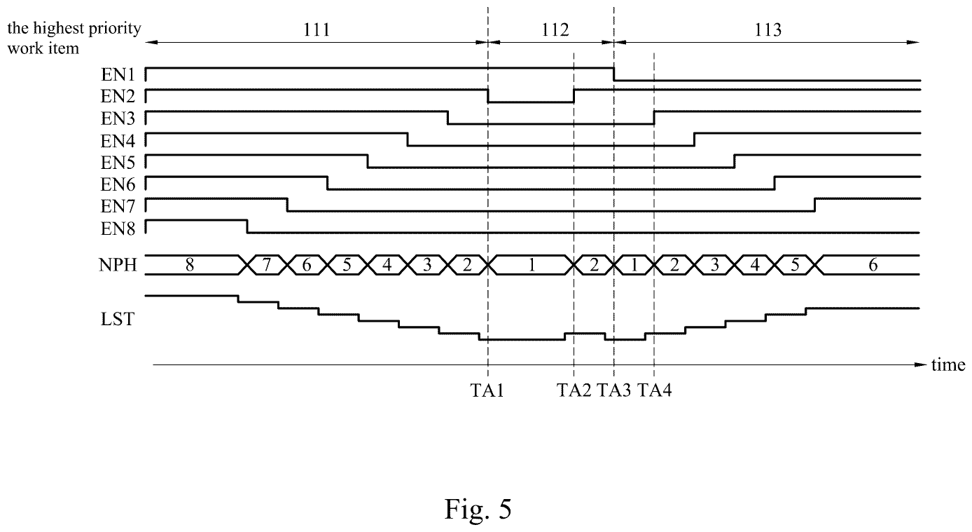

In some embodiments, the detector circuit 130 is configured to detect the load current IOTT, and is configured to transmit the load current IOTT to the controller 120. Furthermore, the controller 120 receives the load current IOTT to determine an activation number NPH (which is shown in FIGS. 5-10 described later) of the phase circuits 111-118, that is, the number of phase circuits which are enabled to be in the active state among the phase circuits 111-118. After determining the activation number NPH of the phase circuits 111-118, the controller 120 further outputs the driving signals PWM1-PWM8 to the multi-phase voltage converter 110 according to an activation order of the phase circuits 111-118, so as to use the driving signals PWM1-PWM8 to control the driver circuits D1-D8 to drive the phase circuits 111-118, respectively. From the above descriptions, it can be seen that the controller 120 is configured to control the phase circuits 111-118 in the multi-phase voltage converter 110 according to the load current IOTT and the activation order of the phase circuits 111-118 in some embodiments.

In accordance with the above descriptions, in some embodiments, the controller 120 further redefines or adjusts the activation order of the phase circuits 111-118 in response to a trigger event. For example, the trigger event may be defined as an event where the activation number NPH of the phase circuits 111-118 becomes 1. When the trigger event occurs, the controller 120 can redefine the highest priority work item in the activation order of the phase circuits 111-118. In an assumption that the phase circuits 111-118 are respectively the first to eighth priority work items, when the trigger event occurs, the controller 120 can redefine or adjust the activation order, to adjust the phase circuit 111 from the first priority work item (i.e., the highest priority work item) to the eighth priority work item (i.e., the last priority work item in the activation order of the phase circuits 111-118), and to adjust the other phase circuits 112-118 respectively from the second to the eighth priority work items to the first to the seventh priority work items, that is, the highest priority work item is updated to the phase circuit 112.

In accordance with the above descriptions, when the activation number NPH increases from 1 to a number greater than 1, one of the phase circuits 111-118, which is regarded as the highest priority work item, will be enabled by the controller 120 from the high impedance state to the active state, so that the corresponding one of the driving signals PWM1-PWM8 is switched between the enable level VH and the disable level VL. When the activation number NPH is reduced to 1, the highest priority work item is updated to another phase circuit, and the phase circuit, which is the previous highest priority work item, is adjusted to the last priority work item. For example, in a condition that the phase circuit 112 is the highest priority work item, when the activation number NPH increases from 1 to a number greater than 1, the controller 120 is configured to prioritize the enabling of the phase circuit 112 to be in the active state. When the activation number NPH is reduced to 1, the highest priority work item is updated from the phase circuit 112 to the phase circuit 113, and the phase circuit 112, which is the previous highest priority work item, is adjusted to the last priority work item. The activation number NPH of the phase circuits 111-118 determines the number of driving signals which will be switched between the enable level VH and the disable level VL (i.e., the number of phase circuits which will be in the active state). In addition, the activation number NPH subtracted from the total number of the phase circuits 111-118 is the number of driving signals which will be maintained at the high impedance level VHIZ (i.e., the number of phase circuits which will be maintained in the high impedance state). In an assumption that the activation number NPH is 3, three of the phase circuits 111-118 are enabled to be in the active state, and the remaining five of the phase circuits 111-118 are disabled to be in the high impedance state.

It should be understood that the voltage conversion system 100 of the present disclosure is not limited to the circuit structure as shown in FIG. 1. For example, the number of phases of the multi-phase voltage converter 110 can be less or greater than 8 (i.e., the number of driver circuits D1-D8 or phase circuits 111-118 in FIG. 1). In another example, the detector circuit 130 can be arranged inside the controller 120, that is, the voltage conversion system 100 includes the multi-phase voltage converter 110 and the controller 120, and the controller 120 can detect the load current IOTT and achieve the above circuit operations.

In the above embodiments, the controller 120 can be implemented by an application-specific integrated circuit (ASIC). Each of the driving signals PWM1-PWM8 can be a pulse width modulation (PWM) signal. Each of the driver circuits D1-D8 can be implemented by a gate driver. The detector circuit 130 can be implemented by a current sensor.

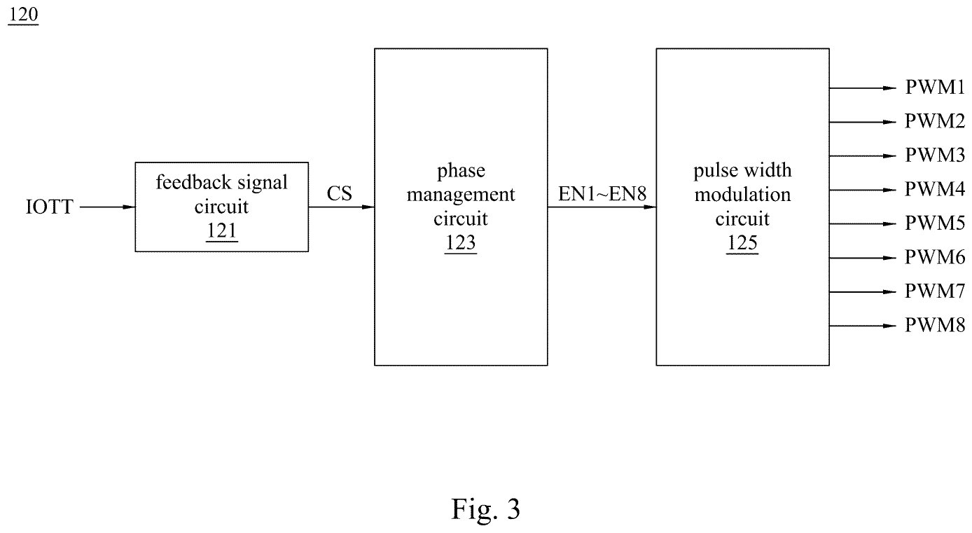

The circuit structure of the controller 120 of the present disclosure will be described in detail below with reference to FIG. 3. FIG. 3 is a circuit block diagram of the controller 120 in accordance with some embodiments of the present disclosure. In some embodiments, the controller 120 includes a feedback signal circuit 121, a phase management circuit 123 and a pulse width modulation circuit 125. The feedback signal circuit 121 is coupled to the detector circuit 130 in FIG. 1 and the phase management circuit 123. The phase management circuit 123 is coupled to the pulse width modulation circuit 125. In addition, the pulse width modulation circuit 125 is coupled to the driver circuits D1-D8 of the multi-phase voltage converter 110 in FIG. 1. As shown in FIG. 3, the feedback signal circuit 121 is configured to generate a control signal CS1 according to the load current IOTT. The phase management circuit 123 is configured to generate a plurality of enabling signals EN1-EN8 according to the control signal CS. The pulse width modulation circuit 125 is configured to generate the driving signals PWM1-PWM8 according to the enabling signals EN1-EN8 respectively.

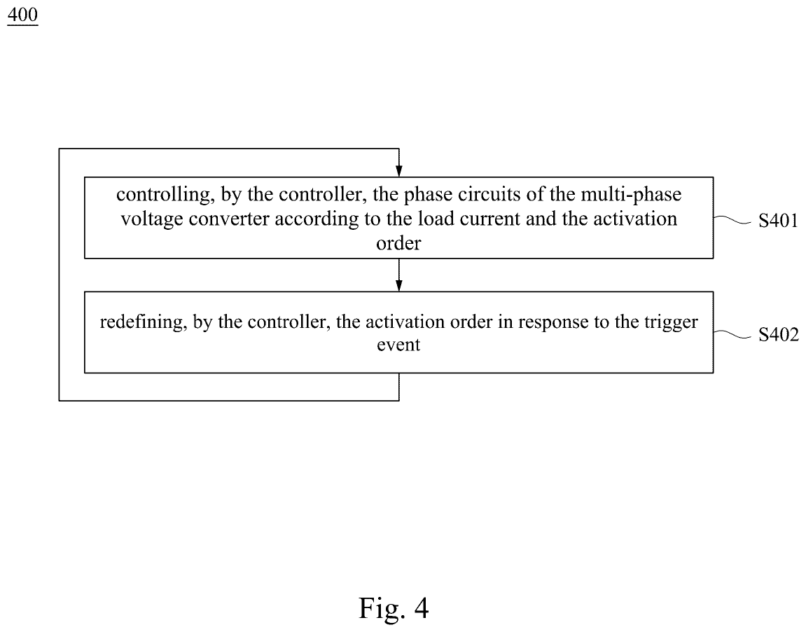

The circuit operation of the controller 120 will be described in detail below with reference to a control method 400 shown in FIG. 4 and multiple scenarios of the load LD shown in FIGS. 5-10. FIG. 4 is a flow diagram of the control method 400 in accordance with some embodiments of the present disclosure. FIGS. 5-10 are timing diagrams of the enabling signals EN1-EN8 under multiple scenarios of the load LD in accordance with some embodiments of the present disclosure. In some embodiments, as shown in FIG. 4, the control method 400 includes multiple operations S401-S402. However, the present disclosure is not limited herein.

In operation S401, the controller 120 controls the phase circuits 111-118 of the multi-phase voltage converter 110 according to the load current IOTT and the activation order.

In some embodiments, during a period before a time point TA1 in FIG. 5, the highest priority work item in the activation order of the phase circuits 111-118 is set to be the phase circuit 111 by the phase management circuit 123. That is to say, the phase circuit 111 is the first priority work item, the phase circuit 112 is the second priority work item, and so on.

During the period before the time point TA1, the feedback signal circuit 121 is aware of a load status LST of the load LD according to the current level of the load current IOTT, and outputs the control signal CS to the phase management circuit 123 according to the load status LST. For example, the control signal CS can indicate that the activation number NPH of the phase circuits 111-118 is 8. In this case, the enabling signals EN1-EN8, which are outputted by the phase management circuit 123 according to the control signal CS, are all at the voltage level corresponding to logic 1. Each of the driving signals PWM1-PWM8, which are outputted by the pulse width modulation circuit 125 according to the enabling signals EN1-EN8 respectively, can have at least one pulse (e.g., a pulse PLS1 in FIG. 2). In other words, each of the driving signals PWM1-PWM8 can at least be switched from the disable level VL to the enable level VH, and then switched from the enable level VH to the disable level VL. Also, each of the phase circuits 111-118 is in the active state, to at least be switched from the discharging state to the charging state and then switched from the charging state to the discharging state. Furthermore, when the enabling signals EN1-EN8 are all at the voltage level corresponding to logic 1, each of the driving signals PWM1-PWM8 has the at least one pulse, and, between any two adjacent driving signals among the driving signals PWM1-PWM8, a predetermined time interval exists between the rising edge of the at least one pulse of one driving signal and the rising edge of the at least one pulse of the adjacent driving signal.

In another example, the activation number NPH of the phase circuits 111-118 changes to 7 in response to the change of the load status LST. In this case, since the last priority work item in the current activation order is the phase circuit 118, the controller 120 will be configured to prioritize the disabling of the phase circuit 118, that is, the phase circuit 118 will be switched from the active state to the high impedance state with priority. Accordingly, the enabling signals EN1-EN7 generated by the phase management circuit 123 according to the control signal CS are all at the voltage level corresponding to logic 1, and the enabling signal EN8 generated by the phase management circuit 123 according to the control signal CS is at the voltage level corresponding to logic 0. Also, each of the driving signals PWM1-PWM7 respectively corresponding to the enabling signals EN1-EN7 can have at least one pulse (e.g., the pulse PLS1 in FIG. 2), while the driving signal PWM8 corresponding to the enabling signal EN8 has no pulse (i.e., the driving signal PWM8 is maintained at the high impedance level VHIZ). Furthermore, each of the phase circuits 111-117 is in the active state, to at least be switched from the discharging state to the charging state and then switched from the charging state to the discharging state, while the phase circuit 118 is maintained in the high impedance state. During the period before the time point TA1, the circuit operations of the phase management circuit 123 and the pulse width modulation circuit 125 when the activation number NPH is any one of 2 to 6 can be deduced from the description of the above example, and thus will be omitted herein.

In operation S402, the controller 120 redefines the activation order in response to the triggering event. In some embodiments, at the time point TA1 shown in FIG. 5, the feedback signal circuit 121 determines to adjust the activation number NPH of the phase circuits 111-118 to 1 according to the load status LST (i.e., the trigger event occurs), and outputs the control signal CS correspondingly to the phase management circuit 123. The phase management circuit 123 receives the control signal CS and switches the enabling signal EN2 from the voltage level corresponding to logic 1 to the voltage level corresponding to logic 0, so that only the phase circuit 111 (which is still the highest priority work item in the current activation order) is constantly enabled to be in the active state in the multi-phase voltage converter 110. Furthermore, since the control signal CS indicates that the activation number NPH of the phase circuits 111-118 is adjusted to 1, the phase management circuit 123 redefines or adjusts the activation order to adjust the phase circuit 111 from the first priority work item (i.e., the highest priority work item) to the eighth priority work item (i.e., the last priority work item), and to adjust other phase circuits 112-118 respectively from the second to the eighth priority work items to the first to the seventh priority work items. From the above descriptions, it can be seen that the controller 120 adjusts the phase circuit 112 from the second priority work item to the highest priority work item in response to the activation number NPH of the phase circuits 111-118 becoming 1.

In accordance with the above descriptions, at the moment of the activation number NPH of the phase circuits 111-118 becoming 1, the controller 120 still enables the phase circuit 111 according to the activation order which is complied during the period before the time point TA1 (i.e., the phase circuits 111-118 are the first to the eighth priority work items respectively). At this time, if the controller 120 is switched to enable the phase circuit 112 instead of continuing enabling the phase circuit 111 when the activation number NPH of the phase circuits 111-118 is not increased to a number greater than 1, the working efficiency of the voltage conversion system 100 will decrease. Therefore, during a period when the highest priority work item is the phase circuit 112 and the activation number NPH of the phase circuits 111-118 is 1 (i.e., a period between the time point TA1 and a time point TA2), the controller 120 continues enabling the phase circuit 111 instead of the phase circuit 112 although the phase circuit 111 is no longer the highest priority work item.

At the time point TA2 shown in FIG. 5, the feedback signal circuit 121 determines to adjust the activation number NPH of the phase circuits 111-118 to 2 according to the load status LST, and outputs the control signal CS correspondingly to the phase management circuit 123. The phase management circuit 123 receives the control signal CS and switches the enabling signal EN2 from the voltage level corresponding to logic 0 to the voltage level corresponding to logic 1 because the highest priority work item is the phase circuit 112, so that both the phase circuits 112 and 111 are in the active state after the time point TA2.

At a time point TA3 shown in FIG. 5, the feedback signal circuit 121 determines to adjust the activation number NPH of the phase circuits 111-118 to 1 according to the load status LST, and outputs the control signal CS correspondingly to the phase management circuit 123. The phase management circuit 123 receives the control signal CS and switches the enabling signal EN1 corresponding to the phase circuit 11 (which is the last priority work item in the current activation order) from the voltage level corresponding to logic 1 to the voltage level corresponding to logic 0, so that only the phase circuit 112 (which is still the highest priority work item in the current activation order) is constantly enabled to be in the active state in the multi-phase voltage converter 110. Furthermore, since the control signal CS indicates that the activation number NPH of the phase circuits 111-118 is adjusted to 1, the phase management circuit 123 redefines or adjusts the activation order to adjust the phase circuit 112 from the first priority work item to the eighth priority work item, to adjust the other phase circuits 113-118 respectively from the second to the seventh priority work items to the first to the sixth priority work items, and to adjust the phase circuits 111 from the eighth priority work item to the seventh priority work item. From the above descriptions, it can be seen that the controller 120 adjusts the phase circuit 113 from the second priority work item to the highest priority work item in response to the activation number NPH of the phase circuits 111-118 becoming 1 (i.e., in response to the trigger event). In addition, similar to the above descriptions, during a period when the highest priority work item is the phase circuit 113 and the activation number NPH of the phase circuits 111-118 is 1 (i.e., during a period between the time point TA3 and a time point TA4), the controller 120 continues enabling the phase circuit 112 instead of the phase circuit 113.

At the time point TA4 shown in FIG. 5, the feedback signal circuit 121 determines to adjust the activation number NPH of the phase circuits 111-118 to 2 according to the load status LST, and outputs the control signal CS correspondingly to the phase management circuit 123. The phase management circuit 123 receives the control signal CS and switches the enabling signal EN3 from the voltage level corresponding to logic 0 to the voltage level corresponding to logic 1 because the highest priority work item is the phase circuit 113, so that both the phase circuits 113 and 112 are in the active state after the time point TA4. During a period after the time point TA4, the circuit operations of the phase management circuit 123 and the pulse width modulation circuit 125 when the activation number NPH gradually increases from 3 to 6 can be deduced from the above descriptions to enable the phase circuits 114-117 sequentially to be in the active state, and thus will be omitted herein.

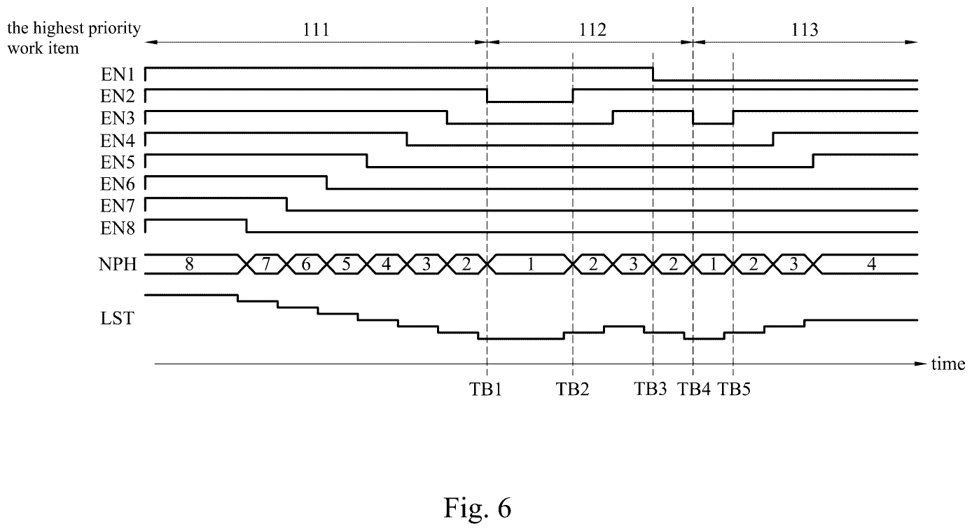

In the embodiments of FIG. 6, the circuit operations of the feedback signal circuit 121, the phase management circuit 123, and the pulse width modulation circuit 125 in the controller 120 during a period before a time point TB1 or a time point TB2 are similar to their circuit operations during the period before the time point TA1 or the time point TA2 in FIG. 5, and thus will be omitted herein.

During a period between the time point TB2 and a time point TB3 shown in FIG. 6, the controller 120 adjusts the activation number NPH of the phase circuits 111-118 from 1 to 2 and then from 2 to 3 according to the load status LST through the feedback signal circuit 121, and enables the phase circuit 112 first and then the phase circuit 113 through the phase management circuit 123 and the pulse width modulation circuit 125. During the time period between the time point TB2 and the time point TB3, the highest priority work item is the phase circuit 112, the second priority work item is the phase circuit 113, and the last priority work item is the phase circuit 111. Therefore, the phase circuits 112, 113 and 111 are in the active state. In brief, when the phase circuit 112 is the highest priority work item, the controller 120 is configured to switch at least the phase circuit 112 (e.g., the phase circuits 112-113) from the high impedance state to the active state starting from the phase circuit 112 according to the current activation order in response to the activation number NPH of the phase circuits 111-118 changing from 1 to a number greater than 1 (e.g., 3).

At the time point TB3 shown in FIG. 6, the controller 120 determines to adjust the activation number NPH of the phase circuits 111-118 from 3 to 2 according to the load status LST through the feedback signal circuit 121, and disables the phase circuit 111 which is the last priority work item through the phase management circuit 123 and the pulse width modulation circuit 125 (i.e., the phase circuit 111 is switched to the high impedance state). Therefore, the phase circuits 112 and 113 are in the active state.

At a time point TB4 shown in FIG. 6, the controller 120 determines to adjust the activation number NPH of the phase circuits 111-118 from 2 to 1 according to the load status LST through the feedback signal circuit 121, and disables the phase circuit 113 in the multi-phase voltage converter 110 which is the second priority work item through the phase management circuit 123 and the pulse width modulation circuit 125 (i.e., the phase circuit 113 is switched to the high impedance state). That is to say, only the phase circuit 112 is in the active state in the multi-phase voltage converter 110 (because the highest priority work item is the phase circuit 112 before the time point TB4). Also, in response to the activation number NPH of the phase circuits 111-118 becoming 1, the controller 120 redefines or adjusts the activation order through the phase management circuit 123, to adjust the phase circuit 113 from the second priority work item to the highest priority work item. Meanwhile, the phase circuit 112 is also adjusted from the highest priority work item to the last priority work item. It should be understood that the phase circuits 114-118 are respectively adjusted to the second to the sixth priority work items, and the phase circuit 111 is adjusted to the seventh priority work item.

During a period after a time point TB5 shown in FIG. 6, the controller 120 determines to adjust the activation number NPH of the phase circuits 111-118 gradually from 1 to 4 according to the load status LST through the feedback signal circuit 121, and enables the phase circuits 113-115 sequentially through the phase management circuit 123 and the pulse width modulation circuit 125. During the period after the time point TB5, the first to the third priority work items are the phase circuits 113-115 respectively, and the last priority work item is the phase circuit 112. Therefore, the phase circuits 113, 114, 115 and 112 are in the active state. In brief, when the phase circuit 113 is the highest priority work item, the controller 120 is configured to switch at least the phase circuit 113 (e.g., the phase circuits 113-115) from the high impedance state to the active state starting from the phase circuit 113 according to the current activation order in response to the activation number NPH of the phase circuits 111-118 changing from 1 to a number greater than 1 (e.g., 4).

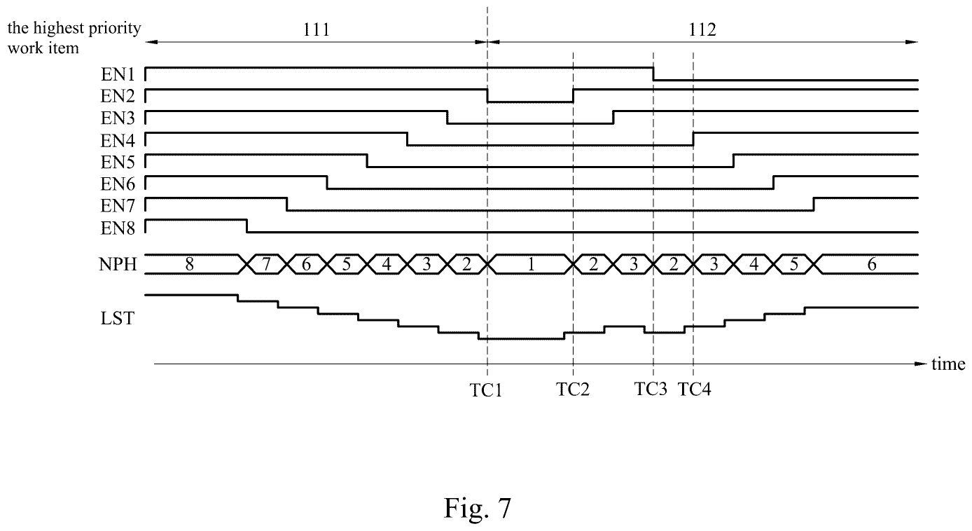

In the embodiments of FIG. 7, the circuit operations of the feedback signal circuit 121, the phase management circuit 123, and the pulse width modulation circuit 125 in the controller 120 during a period before a time point TC1, a time point TC2, a time point TC3 or a time point TC4 are similar to their circuit operations during the period before the time point TB1, the time point TB2, the time point TB3 or the time point TB4 in FIG. 6, and thus will be omitted herein.

At time point TC4 shown in FIG. 7, the phase circuit 112 is the highest priority work item, the phase circuits 113-118 are the second to the seventh priority work items respectively, and the phase circuit 111 is the last priority work item. In addition, the phase circuits 112 and 113 are both in the active state, while the phase circuit 111 and the other phase circuits 114-118 are all in the high impedance state.

During a period after a time point TC4 shown in FIG. 7, the controller 120 determines to adjust the activation number NPH of the phase circuits 111-118 gradually from 2 to 6 according to the load status LST through the feedback signal circuit 121, and enables the phase circuits 114-117 sequentially through the phase management circuit 123 and the pulse width modulation circuit 125. Therefore, the phase circuits 112-117 are all in the active state, while the phase circuits 111 and 118 are all in the high impedance state.

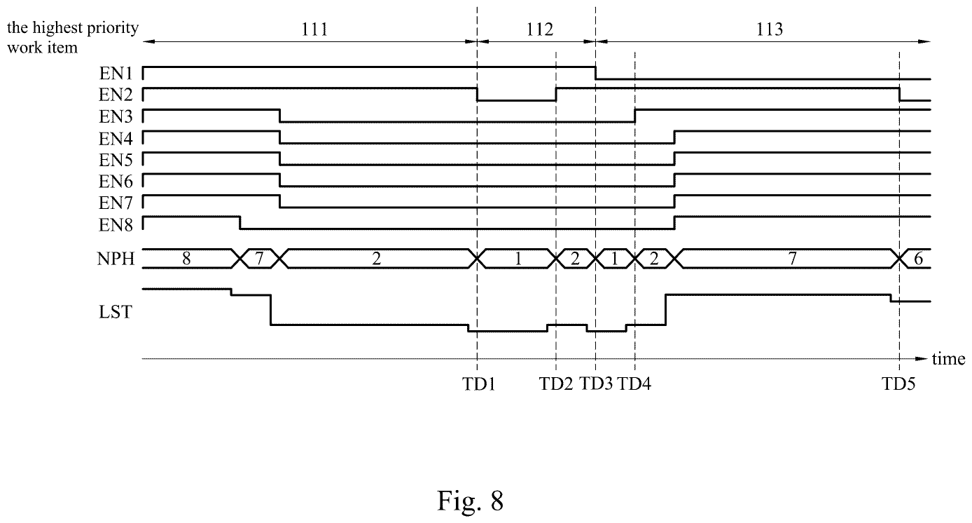

During a period before a time point TD1 shown in FIG. 8, the controller 120 determines to adjust the activation number NPH of the phase circuits 111-118 from 8 to 7 and then from 7 to 2 according to the load status LST through the feedback signal circuit 121. Since the first to the eighth priority work items are the phase circuits 111-118 respectively, the controller 120 first disables the phase circuit 118 and then simultaneously disables the phase circuits 113-117 through the phase management circuit 123 and the pulse width modulation circuit 125. Therefore, the phase circuits 111 and 112 are both in the active state, while other phase circuits 113-118 are all in the high impedance state.

In the embodiments of FIG. 8, the circuit operations of the feedback signal circuit 121, the phase management circuit 123, and the pulse width modulation circuit 125 in the controller 120 at a time point TD1, a time point TD2, a time point TD3 or a time point TD4 are similar to their circuit operations at the time point TA1, the time point TA2, the time point TA3 or the time point TA4 in FIG. 5, and thus will be omitted herein.

During a period between the time point TD4 and a time point TD5 shown in FIG. 8, the controller 120 determines to adjust the activation number NPH of the phase circuits 111-118 from 1 to 2 and then from 2 to 7 according to the load status LST through the feedback signal circuit 121, and first enables the phase circuit 113 and then simultaneously enables the phase circuits 114-118 through the phase management circuit 123 and the pulse width modulation circuit 125. Therefore, the phase circuits 112-118 are all in the active state, while the phase circuit 111 is in the high impedance state.

At the time point TD5 shown in FIG. 8, the feedback signal circuit 121 of the controller 120 determines to adjust the activation number NPH of the phase circuits 111-118 from 7 to 6 according to the load status LST, and outputs the control signal CS correspondingly to the phase management circuit 123. At this time, the phase circuit 113 is the highest priority work item, the phase circuits 114-118 are the second to the sixth priority work items respectively, the phase circuit 111 is the seventh priority work item, and the phase circuit 112 is the last priority work item. The phase management circuit 123 and the pulse width modulation circuit 125 disable the phase circuit 112 (which is the one of the enabled phase circuits 112-118 with the lowest priority (i.e., the one of the enabled phase circuits 112-118 being the last priority work item) before the time point TD5) according to the control signal CS (i.e., the phase circuit 112 is switched to the high impedance state). Therefore, the phase circuits 113-118 are all in the active state, and the phase circuits 111 and 112 are both in the high impedance state.

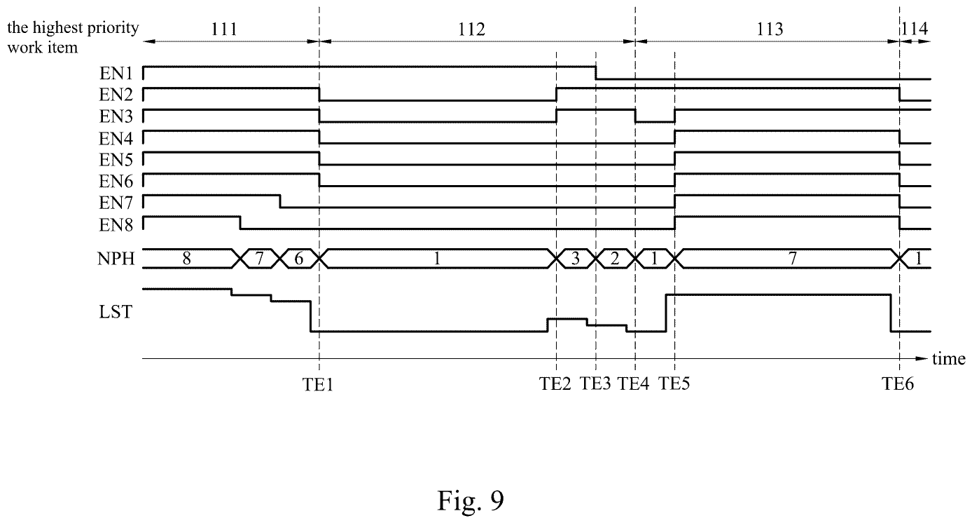

During a period before a time point TE1 shown in FIG. 9, the controller 120 determines to adjust the activation number NPH of the phase circuits 111-118 from 8 to 7 and then from 7 to 6 according to the load status LST through the feedback signal circuit 121. Since the first to the eighth priority work items are the phase circuits 111-118 respectively, the controller 120 first disables the phase circuit 118 and then the phase circuit 117 through the phase management circuit 123 and the pulse width modulation circuit 125. Therefore, the phase circuits 111-116 are all in the active state, while the phase circuits 117 and 118 are both in the high impedance state.

At the time point TE1 shown in FIG. 9, the controller 120 determines to adjust the activation number NPH of the phase circuits 111-118 directly from 6 to 1 according to the load status LST through the feedback signal circuit 121, and disables the phase circuits 112-116 in the multi-phase voltage converter 110 through the phase management circuit 123 and the pulse width modulation circuit 125. That is to say, only the phase circuit 111 is controlled to have the charging state in the multi-phase voltage converter 110 (because the highest priority work item is the phase circuit 111 before the time point TE1). Also, in response to the activation number NPH of the phase circuits 111-118 becoming 1, the controller 120 redefines or adjusts the activation order through the phase management circuit 123, to adjust the phase circuit 112 from the second priority work item to the highest priority work item. Meanwhile, the phase circuit 111 is also adjusted from the highest priority work item to the last priority work item. It should be understood that the phase circuits 113-118 are respectively adjusted to the second to the seventh priority work items.

At a time point TE2 shown in FIG. 9, the controller 120 determines to adjust the activation number NPH of the phase circuits 111-118 directly from 1 to 3 according to the load status LST through the feedback signal circuit 121. Since the phase circuits 112 and 113 are the first and the second priority work items respectively, the controller 120 enables the phase circuits 112 and 113 through the phase management circuit 123 and the pulse width modulation circuit 125. Therefore, the phase circuits 112, 113 and 111 are in the active state, while other phase circuits 114-118 are all in the high impedance state.

At a time point TE3 shown in FIG. 9, the controller 120 determines to adjust the activation number NPH of the phase circuits 111-118 from 3 to 2 according to the load status LST through the feedback signal circuit 121. Since the phase circuit 111 is the last priority work item, the controller 120 disables the phase circuit 111 through the phase management circuit 123 and the pulse width modulation circuit 125. Therefore, the phase circuits 112 and 113 are both in the active state, while other phase circuits 114-118 and 111 are all in the high impedance state.

At a time point TE4 shown in FIG. 9, the controller 120 determines to adjust the activation number NPH of the phase circuits 111-118 from 2 to 1 according to the load status LST through the feedback signal circuit 121, and disables the phase circuit 113 through the phase management circuit 123 and the pulse width modulation circuit 125. That is to say, only the phase circuit 112 is controlled to have the charging state in the multi-phase voltage converter 110 (because the highest priority work item is the phase circuit 112 before the time point TE4). Also, in response to the activation number NPH of the phase circuits 111-118 becoming 1, the controller 120 redefines or adjusts the activation order through the phase management circuit 123, to adjust the phase circuit 113 from the second priority work item to the highest priority work item. Meanwhile, the phase circuit 112 is also adjusted from the highest priority work item to the last priority work item. It should be understood that the phase circuits 114-118 are respectively adjusted to the second to the sixth priority work items, and the phase circuit 111 is adjusted to the seventh priority work item.

At a time point TE5 shown in FIG. 9, the controller 120 determines to adjust the activation number NPH of the phase circuits 111-118 directly from 1 to 7 according to the load status LST through the feedback signal circuit 121. Since the phase circuits 113-118 are the first to the sixth priority work items respectively, the controller 120 enables the phase circuits 113-118 through the phase management circuit 123 and the pulse width modulation circuit 125. Therefore, the phase circuits 113-118 and 112 are all in the active state, while the phase circuit 111 is in the high impedance state.

At a time point TE6 shown in FIG. 9, the controller 120 determines to adjust the activation number NPH of the phase circuits 111-118 directly from 7 to 1 according to the load status LST through the feedback signal circuit 121, and disables the phase circuits 112 and 114-118 through the phase management circuit 123 and the pulse width modulation circuit 125. That is to say, only the phase circuit 113 is controlled to have the charging state in the multi-phase voltage converter 110 (because the highest priority work item is the phase circuit 113 before the time point TE6). Also, in response to the activation number NPH of the phase circuits 111-118 becoming 1, the controller 120 redefines or adjusts the activation order through the phase management circuit 123, to adjust the phase circuit 114 from the second priority work item to the highest priority work item. Meanwhile, the phase circuit 113 is also adjusted from the highest priority work item to the last priority work item. It should be understood that the phase circuits 115-118 are respectively adjusted to the second to the fifth priority work items, the phase circuit 111 is adjusted to the sixth priority work item, and the phase circuit 112 is adjusted to the seventh priority work item.

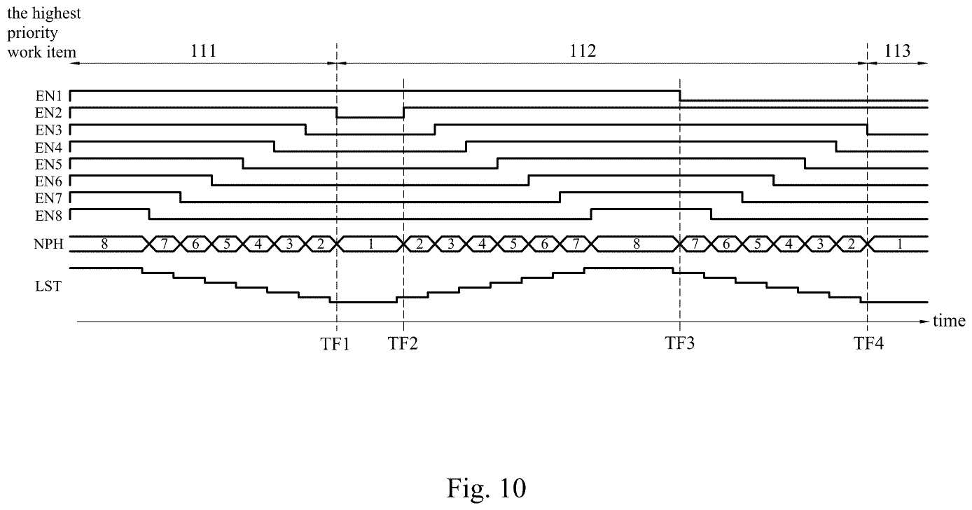

In the embodiments of FIG. 10, the circuit operations of the feedback signal circuit 121, the phase management circuit 123, and the pulse width modulation circuit 125 in the controller 120 during a period before a time point TF1 or a time point TF2 are similar to their circuit operations during the period before the time point TA1 or the time point TA2 in FIG. 5, and thus will be omitted herein.

During a period between the time point TF2 and a time point TF3 shown in FIG. 10, the controller 120 determines to adjust the activation number NPH of the phase circuits 111-118 gradually from 1 to 8 according to the load status LST through the feedback signal circuit 121, and enables the phase circuits 112-118 sequentially through the phase management circuit 123 and the pulse width modulation circuit 125. Therefore, the phase circuits 112-118 and 111 are all in the active state.

During a period between the time point TF3 and a time point TF4 shown in FIG. 10, the controller 120 determines to adjust the activation number NPH of the phase circuits 111-118 gradually from 8 to 2 according to the load status LST through the feedback signal circuit 121, and disables the phase circuits 111, 118, 117, 116, 115 and 114 (which are the eighth, the seventh, the sixth, the fifth, the fourth and the third priority work items respectively) sequentially through the phase management circuit 123 and the pulse width modulation circuit 125. Therefore, the phase circuits 112 and 113 are all in the active state, and the phase circuits 114-118 and 111 are all in the high impedance state.

At a time point TF4 shown in FIG. 10, the controller 120 determines to adjust the activation number NPH of the phase circuits 111-118 from 2 to 1 according to the load status LST through the feedback signal circuit 121, and disables the phase circuit 113 through the phase management circuit 123 and the pulse width modulation circuit 125. That is to say, only the phase circuit 112 is controlled to have the charging state in the multi-phase voltage converter 110 (because the highest priority work item is the phase circuit 112 before the time point TF4). Also, in response to the activation number NPH of the phase circuits 111-118 becoming 1, the controller 120 redefines or adjusts the activation order through the phase management circuit 123, to adjust the phase circuit 113 from the second priority work item to the highest priority work item. Meanwhile, the phase circuit 112 is also adjusted from the highest priority work item to the last priority work item. It should be understood that the phase circuits 114-118 are respectively adjusted to the second to the sixth priority work items, and the phase circuit 111 is adjusted to the seventh priority work item.

In the above embodiments, when the activation number NPH of the phase circuits 111-118 becomes 1, the controller 120 redefines or adjusts the activation order of the phase circuits 111-118 through the phase management circuit 123, but the present disclosure is not limited herein. For example, in some embodiments, the controller 120 adjusts the activation order of the phase circuits 111-118 through the feedback signal circuit 121 or an extra circuit (not shown), and the feedback signal circuit 121 or the extra circuit will transmit the adjusted activation order to the phase management circuit 123.

As can be seen from the above embodiments of the present disclosure, by the controller 120 redefining or adjusting the activation order of the phase circuits 111-118 in response to the activation number NPH of the phase circuits 111-118 becoming 1 (i.e., in response to the trigger event), the voltage conversion system 100 of the present disclosure can average the duty cycles of the phase circuits 111-118 in the multi-phase voltage converter 110, so as to achieve the technical effects of effectively improving the efficiency and reliability of the voltage conversion system 100.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A voltage conversion system, comprising:
a multi-phase voltage converter, coupled to a load and comprising a plurality of phase circuits, wherein the plurality of phase circuits are coupled to the load, and at least one of the plurality of phase circuits is in an active state, so that the multi-phase voltage converter provides a load current to the load; and
a controller, coupled to the multi-phase voltage converter, configured to enable at least one of the plurality of phase circuits to be in the active state according to the load current and an activation order of the plurality of phase circuits, and configured to adjust the activation order in response to an activation number of the plurality of phase circuits becoming 1, so as to adjust a first one of the plurality of phase circuits from a second priority work item to a highest priority work item.

2. The voltage conversion system of claim 1, wherein when the first one of the plurality of phase circuits is adjusted from the second priority work item to the highest priority work item, a second one of the plurality of phase circuits is adjusted from the highest priority work item to a last priority work item.

3. The voltage conversion system of claim 2, wherein when the activation number of the plurality of phase circuits becomes 1, the second one of the plurality of phase circuits is in the active state, and the others of the plurality of phase circuits are in a high impedance state.

4. The voltage conversion system of claim 2, wherein when the activation number of the plurality of phase circuits changes from 1 to 2, the first one and the second one of the plurality of phase circuits are in the active state, and the others of the plurality of phase circuits are in a high impedance state.

5. The voltage conversion system of claim 2, wherein when the first one of the plurality of phase circuits is the highest priority work item, the controller is configured to switch at least the first one of the plurality of phase circuits from a high impedance state to the active state starting from the first one of the plurality of phase circuits according to the activation order in response to the activation number of the plurality of phase circuits changing from 1 to a number greater than 1.

6. The voltage conversion system of claim 5, wherein when the first one of the plurality of phase circuits is the highest priority work item, the controller is configured to adjust the activation order in response to the activation number of the plurality of phase circuits becoming 1, to adjust a third one of the plurality of phase circuits from the second priority work item to the highest priority work item.

7. The voltage conversion system of claim 6, wherein when the third one of the plurality of phase circuits is adjusted from the second priority work item to the highest priority work item, the first one of the plurality of phase circuits is adjusted from the highest priority work item to the last priority work item.

8. The voltage conversion system of claim 7, wherein when the third one of the plurality of phase circuits is the highest priority work item, the controller is configured to switch at least the third one of the plurality of phase circuits from the high impedance state to the active state starting from the third one of the plurality of phase circuits according to the activation order in response to the activation number of the plurality of phase circuits changing from 1 to a number greater than 1.

9. The voltage conversion system of claim 1, wherein the multi-phase voltage converter further comprises:
a plurality of driver circuits, coupled to the plurality of phase circuits and the controller, and configured to drive the plurality of phase circuits according to a plurality of driving signals outputted by the controller.

10. The voltage conversion system of claim 9, wherein the controller comprises:
a feedback signal circuit, configured to output a control signal according to the load current, wherein the control signal is configured to indicate the activation number of the plurality of phase circuits;
a phase management circuit, coupled to the feedback signal circuit, configured to output a plurality of enabling signals according to the control signal, and configured to adjust the activation order of the plurality of phase circuits in response to the activation number of the plurality of phase circuits becoming 1; and
a pulse width modulation circuit, coupled to the phase management circuit and the multi-phase voltage converter, and configured to output the plurality of driving signals to the multi-phase voltage converter according to the plurality of enabling signals.

11. A control method, applicable to a voltage conversion system comprising a multi-phase voltage converter, wherein the multi-phase voltage converter comprises a plurality of phase circuits, the plurality of phase circuits are configured to couple a load, at least one of the plurality of phase circuits is in an active state so that the multi-phase voltage converter provides a load current to the load, and the control method comprises:
enabling, by a controller of the voltage conversion system, at least one of the plurality of phase circuits to be in the active state according to the load current and an activation order of the plurality of phase circuits; and
adjusting, by the controller, the activation order in response to an activation number of the plurality of phase circuits becoming 1, so as to adjust a first one of the plurality of phase circuits from a second priority work item to a highest priority work item.

12. The control method of claim 11, further comprising:
when the first one of the plurality of phase circuits is adjusted from the second priority work item to the highest priority work item, adjusting, by the controller, a second one of the plurality of phase circuits from the highest priority work item to a last priority work item.

13. The control method of claim 12, further comprising:
when the activation number of the plurality of phase circuits becomes 1, controlling, by the controller, the second one of the plurality of phase circuits to be in the active state, and controlling, by the controller, the others of the plurality of phase circuits to be in a high impedance state.

14. The control method of claim 12, further comprising:
when the activation number of the plurality of phase circuits changes from 1 to 2, controlling, by the controller, the first one and the second one of the plurality of phase circuits to be in the active state, and controlling, by the controller, the others of the plurality of phase circuits to be in a high impedance state.

15. The control method of claim 12, further comprising:
when the first one of the plurality of phase circuits is the highest priority work item, switching, by the controller, at least the first one of the plurality of phase circuits from a high impedance state to the active state starting from the first one of the plurality of phase circuits according to the activation order in response to the activation number of the plurality of phase circuits changing from 1 to a number greater than 1.

16. The control method of claim 15, further comprising:
when the first one of the plurality of phase circuits is the highest priority work item, adjusting, by the controller, the activation order in response to the activation number of the plurality of phase circuits becoming 1, to adjust a third one of the plurality of phase circuits from the second priority work item to the highest priority work item.

17. The control method of claim 16, further comprising:
when the third one of the plurality of phase circuits is adjusted from the second priority work item to the highest priority work item, adjusting, by the controller, the first one of the plurality of phase circuits from the highest priority work item to the last priority work item.

18. The control method of claim 17, further comprising:
when the third one of the plurality of phase circuits is the highest priority work item, switching, by the controller, at least the third one of the plurality of phase circuits from the high impedance state to the active state starting from the third one of the plurality of phase circuits according to the activation order in response to the activation number of the plurality of phase circuits changing from 1 to a number greater than 1.

19. The control method of claim 11, wherein enabling at least one of the plurality of phase circuits to be in the active state according to the load current and the activation order comprises:
outputting, by the controller, a plurality of driving signals to a plurality of driver circuits of the multi-phase voltage converter, to control the plurality of driver circuits to drive at least one of the plurality of phase circuits.

20. The control method of claim 19, wherein outputting the plurality of driving signals to the plurality of driver circuits of the multi-phase voltage converter comprises:
outputting, by a feedback signal circuit of the controller, a control signal according to the load current, wherein the control signal is configured to indicate the activation number of the plurality of phase circuits;
outputting, by a phase management circuit of the controller, a plurality of enabling signals according to the control signal, wherein the phase management circuit is configured to adjust the activation order of the plurality of phase circuits in response to the activation number of the plurality of phase circuits becoming 1; and
outputting, by a pulse width modulation circuit of the controller, the plurality of driving signals to the multi-phase voltage converter according to the plurality of enabling signals.
